(19) United States
(12) Patent Application Publication
(10) Pub. No.: US 2018/0074956 A1
(43) Pub. Date: Mar. 15, 2018

(54) METHOD, APPARATUS, AND ELECTRONIC DEVICE FOR MODIFYING MEMORY DATA OF A VIRTUAL MACHINE

(71) Applicant: ALIBABA GROUP HOLDING LIMITED, George Town (KY)

(72) Inventor: Shanpei CHEN, Beijing (CN)

(73) Assignee: ALIBABA GROUP HOLDING LIMITED

(21) Appl. No.: 15/700,012

(22) Filed: Sep. 8, 2017

(30) Foreign Application Priority Data
Sep. 9, 2016 (CN) 201610814924.4

(51) Int. Cl. G06F 12/08; G06F 9/455

(52) U.S. Cl. CPC G06F 12/08; G06F 2212/657; G06F 2009/45583; G06F 9/45558

(57) ABSTRACT

A method, an apparatus, and an electronic device for modifying memory data of a virtual machine are provided. The method can include: acquiring a physical address offset of a target object relative to an initial point of a kernel loading space of an operating system of the virtual machine, and acquiring a position offset of the memory data of the virtual machine in a virtual machine status file; determining a position of the target object in the virtual machine status file according to the physical address offset and the position offset; and modifying the virtual machine status file according to the determined position. The present application can modify memory data of a virtual machine offline.

### CROSS REFERENCE TO RELATED APPLICATION

The disclosure claims the benefits of priority to Chinese Application No. 201610814924.4, filed Sep. 9, 2016, which is incorporated herein in its entirety.

### BACKGROUND

A Virtual Machine (VM) refers to a full computer system simulated through software. The VM can have full hardware system functions, and run in a fully isolated environment.

Resources of the virtual machine can at least include: a CPU, a memory, a network, a magnetic disk, and the like. For example, a virtual machine supervision program can isolate memory resources of a host through a hardware-assisted virtualization technology, and provide a continuous addressing storage space for the virtual machine. Therefore, the memory used by the virtual machine is a part of the memory of the host. Conventionally, there is no solution to perform an offline modification on data in the memory of the virtual machine.

### SUMMARY

The present disclosure provides a method, an apparatus, and an electronic device for modifying memory data of a virtual machine, which can modify the memory data of the virtual machine offline.

Embodiments of the disclosure provide a method for modifying memory data of a virtual machine. The method can include: acquiring a physical address offset of a target object relative to an initial point of a kernel loading space of an operating system of the virtual machine, and acquiring a position offset of the memory data of the virtual machine in a virtual machine status file; determining a position of the target object in the virtual machine status file according to the physical address offset and the position offset; and modifying the virtual machine status file according to the determined position.

In some embodiments, determining a position of the target object in the virtual machine status file according to the physical address offset and the position offset includes: obtaining an initial position of the target object in the virtual machine status file according to the physical address offset, the position offset, and an initial physical address of the kernel loading space of the operating system of the virtual machine.

Further, acquiring a physical address offset of a target object relative to an initial point of a kernel loading space of an operating system of the virtual machine can include: acquiring a virtual address of the target object; and subtracting an initial virtual address of the kernel loading space of the operating system of the virtual machine from the virtual address of the target object, and using a subtraction result as the physical address offset.

The method can further include: acquiring a kernel version of the operating system of the virtual machine, and acquiring a kernel symbol file corresponding to the kernel version; and reading the virtual address of the target object from the acquired kernel symbol file.

Moreover, acquiring a position offset of the memory data of the virtual machine in a virtual machine status file can include: acquiring, through a virtual machine supervision program, an offset of an initial point of the memory data of the virtual machine relative to an initial point of the virtual machine status file in the virtual machine status file.

Embodiments of the disclosure provide an apparatus for modifying memory data of a virtual machine. The apparatus can include: an acquisition module configured to acquire a physical address offset of a target object relative to an initial point of a kernel loading space of an operating system of the virtual machine, and acquire a position offset of the memory data of the virtual machine in a virtual machine status file; a determination module configured to determine a position of the target object in the virtual machine status file according to the physical address offset and the position offset; and a modification module configured to modify the virtual machine status file according to the determined position.

In some embodiments, the determination module is further configured to obtain an initial position of the target object in the virtual machine status file according to the physical address offset, the position offset, and an initial physical address of the kernel loading space of the operating system of the virtual machine.

Further, the acquisition module can be further configured to: acquire a virtual address of the target object; and subtract an initial virtual address of kernel loading of the operating system of the virtual machine from the virtual address of the target object, and using a subtraction result as the physical address offset.

Moreover, the acquisition module can be further configured to acquire a kernel version of the operating system of the virtual machine, and acquire a kernel symbol file corresponding to the kernel version; and read the virtual address of the target object from the acquired kernel symbol file.

In some embodiments, the acquisition module can be further configured to acquire, through a virtual machine supervision program, an offset of an initial point of the memory data of the virtual machine relative to an initial point of the virtual machine status file in the virtual machine status file.

An electronic device for modifying memory data of a virtual machine, including: a memory and a processor; wherein the memory is configured to store instructions for modifying the memory data of the virtual machine, and when the instructions are read and executed by the processor, the following operations are performed:

acquiring a physical address offset of a target object relative to an initial point of a kernel loading space of an operating system of the virtual machine, and acquiring a position offset of the memory data of the virtual machine in a virtual machine status file;

determining a position of the target object in the virtual machine status file according to the physical address offset and the position offset; and

modifying the virtual machine status file according to the determined position.

### BRIEF DESCRIPTION OF THE DRAWINGS

FIG. 1A illustrates an exemplary computer system for implementing embodiments and features, consistent with the present disclosure.

FIG. 1B illustrates another exemplary computer system for implementing embodiments and features, consistent with the present disclosure.

FIG. 2 illustrates an exemplary virtualization environment, consistent with embodiments of the present disclosure.

FIG. 3 is a flowchart of a method for modifying memory data of a virtual machine, consistent with embodiments of the present disclosure.

FIG. 4 illustrates a schematic diagram of a principle, consistent with embodiments of the present disclosure.

FIG. 5 is a flowchart of a modification process, consistent with embodiments of the present disclosure.

FIG. 6 illustrates a schematic diagram of an apparatus for modifying memory data of a virtual machine, consistent with embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

Embodiments of the present disclosure can modify memory data of a virtual machine offline. In some embodiments, when a virtual address and a physical address are in a linear corresponding relationship, a physical address offset can be determined directly through a virtual address offset.

It should be noted that, without a conflict, the embodiments of the present application and features in the embodiments can be combined with each other, all of which fall within the protection scope of the present application. In addition, although a logic order is illustrated in the flowchart, under some circumstances, the steps illustrated or described may be performed in an order different from the order here.

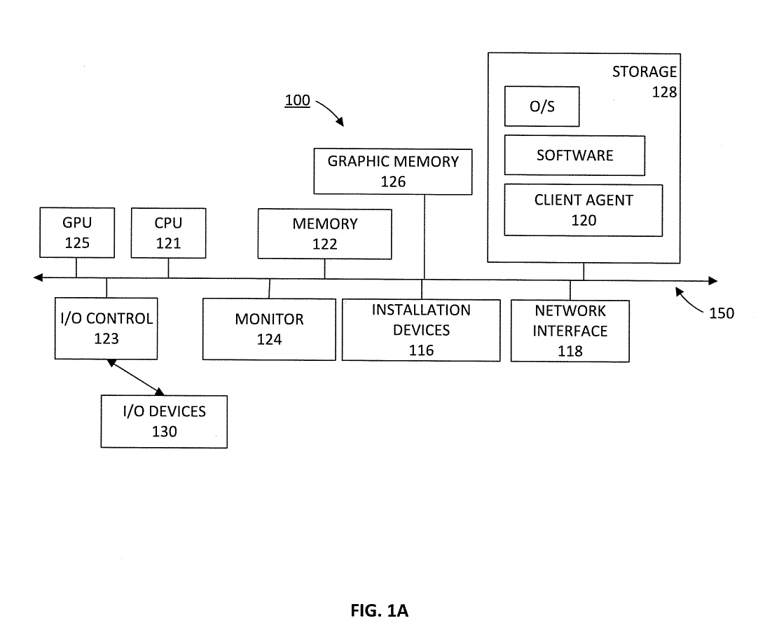

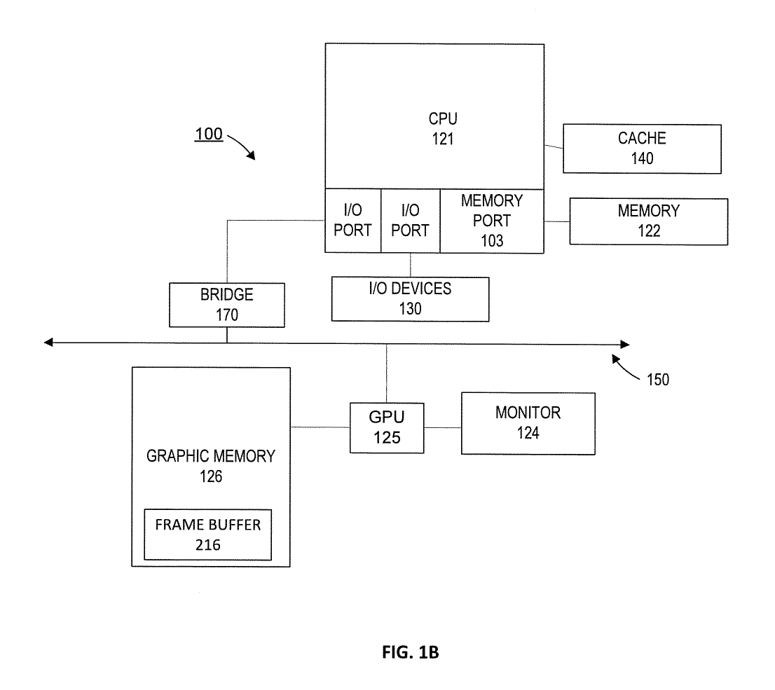

FIGS. 1A-1B are block diagrams illustrating an exemplary computer system 100 that can be used for implementing embodiments consistent with the present disclosure, including the exemplary systems and methods described herein. A computer system 100 can be used for modifying memory data of a virtual machine. The arrangement and number of components in computer system 100 is provided for purposes of illustration. Additional arrangements, number of components, or other modifications can be made, consistent with the present disclosure.

As shown in FIGS. 1A-1B, a computer system 100 can include one or more central processing units (CPUs) 121 for executing instructions. CPU(s) 121 can include any logic circuitry that responds to and processes instructions received from one or more memories 122 and/or storage devices 128. CPU(s) 121 can include a single or multiple microprocessors, field-programmable gate arrays (FPGAs), or digital signal processors (DSPs) capable of executing particular sets of instructions stored in one or more memories 122, storage devices 128, and/or caches (e.g., cache(s) 140).

A computer system 100 can include one or more memories 122, storage devices 128, and/or caches 140, configured to store data and/or software instructions used by CPU(s) 121 to perform operations consistent with disclosed embodiments. For example, computer system 100 can include one or more memories 122 and/or storage devices 128 configured to store one or more software programs that, when executed by CPU(s) 121, cause CPU(s) 121 to perform functions and/or operations consistent with disclosed embodiments. By way of example, a memory 122 and/or storage device 128 can include one or more tangible and/or non-transitory computer-readable mediums, such as NOR or NAND flash memory devices, flexible disks, hard disks, read-only memories (ROMs), random access memories (RAMs), compact disk read-only memories (CD ROMs), magneto-optical (MO) drives, digital versatile disk read-only memories (DVD-ROMs), digital versatile disk random-access memories (DVD-RAMs), semiconductor memories, tape drives, redundant array of independent disks (RAID arrays), etc. A memory 122 and/or storage device 128 can include one or more memory chips capable of storing data and/or allowing storage locations to be directly accessed by CPU(s) 121. In some embodiments, CPU(s) can communicate with one or more memories 122 and/or storage devices 128 via a system bus 150. A computer system 100 can include any number of memories 122 and/or storage devices 128. Memories 122 and/or storage devices 128 can be located remotely and computer system 100 can be able to access other memories 122 and/or storage devices 128 via a network, such as private network(s) and/or public network(s). One or more memories 122 and/or storage devices 128 can be configured to store data, and can store data received from one or more server(s), backend system(s), and/or client device(s). One or more memories 122 and/or storage devices 128 can also store one or more operating systems, application software programs, and/or other software.

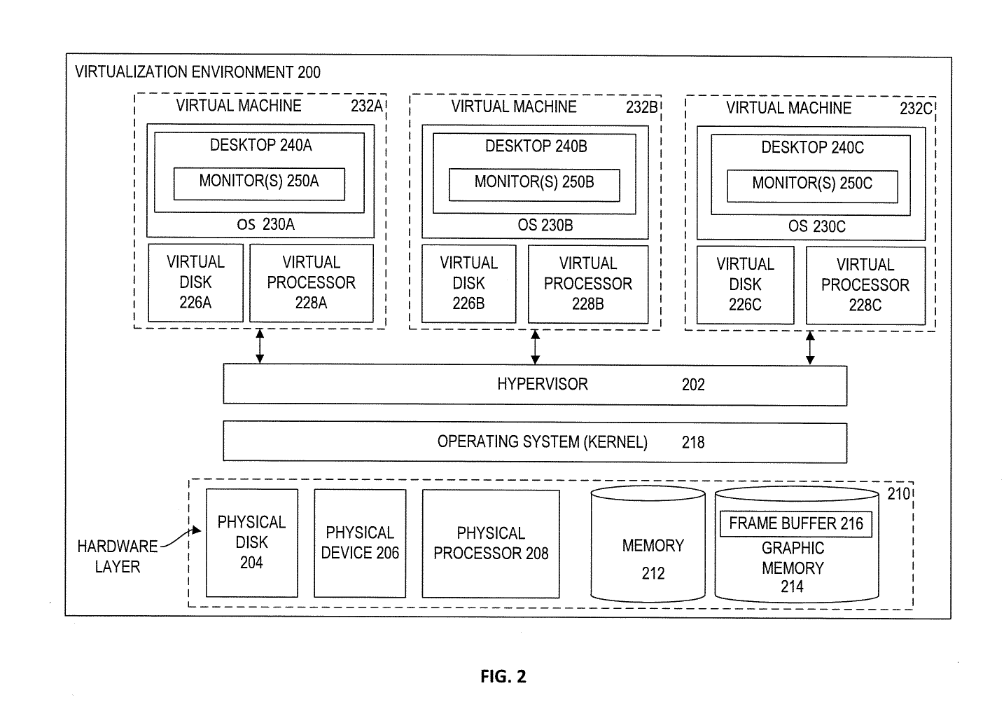

A computer system 100 can also include one or more graphics processing units (GPUs) 125. A GPU 125 can be any type of specialized circuitry that can manipulate and alter memory (e.g., a graphic memory 126) to provide and/or accelerate the creation of images stored in a frame buffer (e.g., frame buffer 216 shown in FIG. 1B and FIG. 2) for output to one or more physical monitors (e.g., physical monitor(s) 124). GPUs can have a highly parallel structure making them more effective than CPUs 121 for algorithms where processing of large blocks of graphical data can be performed in parallel. Furthermore, the functionality of one or more GPUs 125 can also be included in a chipset in some other type of special purpose processing unit or co-processor.

CPU(s) 121 can connect to system interface(s) 150, and can connect with one or more memories 122 and/or storage devices 128 over system interface(s) 150. CPU(s) 121 can also communicate with one or more memories 122 and/or storage devices 128 over a serial communication bus and/or using point-to-point communication. Similarly, GPU(s) 125 can communicate with one or more graphic memories 126, memories 122, and/or storage devices 128 using system interface(s) 150 and/or using other types of busses. CPU(s) 121 can execute programming instructions stored in one or more memories 122, operate on data stored in one or more memories 122, and/or communicate with GPU(s) 125 through system interface(s) 150, which bridge communication between CPU(s) 121 and GPU(s) 125. In some embodiments, CPU(s) 121, GPU(s) 125, system interface(s) 150, or any combination thereof, can be integrated into a single processing unit. GPU(s) 125 can be capable of executing particular sets of instructions stored in one or more memories 122 to manipulate graphical data stored in one or more memories 122 and/or one or more graphic memories 126. For example, GPU(s) 125 can receive instructions transmitted by CPU(s) 121 and process the instructions in order to render graphics data stored in one or more graphic memories 126. A graphic memory 126 can be any memory accessible by GPU(s) 125, including a local memory, a system memory, an on-chip memory, a hard disk, and/or any other type of memory 122 or storage device 128. GPU(s) 125 can enable displaying of graphical data stored in one or more graphic memories 126 on physical monitor(s) 124.

A computer system 100 can also include one or more physical monitors 124 for displaying data and information. Physical monitor(s) 124 can be implemented using one or more display panels, which can include, for example, one or more cathode ray tube (CRT) displays, liquid crystal displays (LCDs), plasma displays, light emitting diode (LED) displays, touch screen type displays, projector displays (e.g., images projected on a screen or surface, holographic images, etc.), organic light emitting diode (OLED) displays, field emission displays (FEDs), active matrix displays, vacuum fluorescent (VFR) displays, 3-dimensional (3-D) displays, electronic paper (e-ink) displays, microdisplays, or any combination of the above types of displays.

A computer system 100 can further include one or more input/output (I/O) devices 130 connected through an I/O controller 123, both of which can communicate via system interface(s) 150. An I/O device 130 can include, for example, one or more keys, buttons, keyboards, mice, joysticks, styluses, gesture sensors (e.g., video cameras), and/or voice sensors (e.g., microphones). Keys, keyboards, and/or buttons can be physical and/or virtual (e.g., provided on a touch screen interface). I/O device(s) 130 can also include a storage device and/or an installation medium for one or more of client devices.

A computer system 100 can support one or more installation devices 116, such as floppy disk drives for receiving floppy disks (e.g., 3.5-inch, 5.25-inch, or Zip Disks), CD-ROM drives, CD-R/RW (readable/rewritable compact disc) drives, DVD-ROM drives, tape drives, universal serial bus (USB) devices, hard-drives, and/or any other device suitable for installing software and programs, such as a client agent 120, or portion thereof Installation device(s) 116 could also be used as storage device(s) 128.

A computer system 100 can further include one or more network interfaces 118 for interfacing to a network, such as a PAN, LAN, MAN, WAN, and/or the Internet through a variety of connections, including, but not limited to, standard telephone lines, LAN or WAN links (e.g., 802.11, T1, T3, 56 kb, X.25), broadband connections (e.g., integrated services digital network (ISDN), Frame Relay, asynchronous transfer mode (ATM)), wireless connections, or some combination of any or all of the above. Network interface(s) 118 can comprise a built-in network adapter, network interface card, personal computer memory card international association (PCMCIA) network card, card bus network adapter, wireless network adapter, USB network adapter, modem, and/or any other device suitable for interfacing computer system 100 to any type of network.

As illustrated in FIG. 1B, CPU(s) 121 of a computer system 100 can communicate directly with one or more memories 122 via one or more memory ports 103, and similarly GPU(s) 125 can communicate directly with one or more graphic memories 126. CPU(s) 121 can also communicate with cache(s) 140 via one or more secondary busses, sometimes referred to as backside busses. In some embodiments, CPU(s) 121 can communicate with cache(s) 140 via system interface(s) 150. A cache 140 can have a faster response time than a memory 122. In some embodiments, such as in the embodiments illustrated in FIG. 1B, CPU(s) 121 can communicate directly with I/O device(s) 130 via one or more I/O ports. In further embodiments, I/O device(s) 130 can include one or more bridges 170 between system interface(s) 150 and one or more external communication busses, such as USB busses, Apple Desktop Busses, RS-232 serial connections, small computer system interface (SCSI) busses, FireWire busses, Ethernet busses, ATM busses, high performance parallel interface (HIPPI) busses, Super HIPPI busses, SerialPlus busses, SCl/LAMP busses, FibreChannel busses, and/or Serial Attached small computer system interface busses.

As shown in FIG. 1B, GPU(s) 125 can also communicate directly with one or more graphic memories 126, memories 122, storage devices 128, and/or monitor(s) 124. GPU(s) 125 can communicate with CPU(s) 121 and/or other devices through system interface(s) 150. One or more graphic memories 126 can also include one or more frame buffers 216 A frame buffer 216 can be a graphic output device that drives one or more physical monitors (e.g., physical monitor(s) 124) from one or more memory buffers of one or more graphic memories 126 containing a complete frame of graphical data. Frame buffer(s) 216 can store one or more final graphical frames, which are to be displayed on physical monitor(s) 124.

FIG. 2 is a block diagram illustrating an exemplary virtualization environment 200. In some embodiments, virtualization environment 200 can be implemented on a computer system 100. A computer system 100 that implements a virtualization environment 200 can be referred to as a host computer system. In some embodiments, the modules, programs, virtual machines, and/or commands stored and/or executed by virtualization environment 200 can be executed by more than one computer system 100.

Virtualization environment 200 can include a hardware layer 210 that can include one or more physical disks 204, one or more physical devices 206, one or more physical processors 208, one or more memories 212, and one or more graphical memories 214. In some embodiments, one or more frame buffers 216 can be stored within one or more memory elements in one or more graphic memories 214, and can be accessed by one or more physical processors 208.

A physical disk 204 can be either an internal or an external physical hard disk, such as a disk of one of the memories 122 and/or storage devices 128 described with reference to FIGS. 1A-1B. Physical and/or virtual elements in a virtualization environment 200 can communicate with physical disk(s) 204 to store and/or retrieve data. Physical device(s) 206 can include one or more virtual devices included in virtualization environment 200 and/or external physical devices that can communicate with virtualization environment 200. A physical device can be any device, such as a network interface card, a video card, a keyboard, a pointing device, an input device, a physical monitor, a speaker, an optical drive, a storage device, a USB connection, a printer, a scanner, any device connected to virtualization environment 200, or any device communicating with virtualization environment 200. A pointing device can be, for example, a mouse, stylus, trackball, joystick, pointing stick, human finger, any input device disclosed with reference to computing system 100, or any other input interface that can allow a user to input spatial data to a computing device. In some embodiments, physical processor(s) 208 can include one or more CPUs 121 and/or GPUs 125.

Virtualization environment 200 can include one or more memories 212. A memory 212 can include any type of memory that can store data, programs, firmware, and/or executable instructions. In some embodiments, a memory 212 can include one or more memories 122. Programs, firmware, and/or executable instructions stored in one or more memories 212 can be executed by one or more physical processors 208 of virtualization environment 200. One or more graphic memories 214 can include any memory accessible by physical processor(s) 208, including local memory, system memory, on-chip memory, and hard disks. In some embodiments, a graphic memory 214 can include one or more graphic memories 126. Physical processor(s) 208 can cause certain graphics corresponding to graphical data stored in one or more graphic memories 214 to be displayed on a physical monitor (e.g., one of physical device(s) 206, which can correspond to a physical monitor 124).

Virtualization environment 200 can further include an operating system 218 that can be stored in one or more memories 212 and executed by one or more physical processors 208. Operating system 218 can also be referred to as a kernel. Moreover, virtualization environment 200 can include a hypervisor 202. Hypervisor 202 can be a program executed by physical processor(s) 208 in virtualization environment 200 to manage any number of virtual machines. In some embodiments, hypervisor 202 can be any combination of executable instructions and/or hardware that monitors virtual machines executing on a computer system 100, such as a server. Hypervisor 202 can be stored in one or more memories 212.

Hypervisor 202 can allocate physical resources from a hardware layer 210 and/or virtual resources to one or more virtual machines, e.g., virtual machines 232A-C. A virtual machine can be a software-based emulation of a physical machine, such as a computer system 100. A virtual machine 232A-C can further include a software-based emulation of the execution of software programs on such a physical machine. For example, a virtual machine can emulate the execution of an operating system and/or application on a particularly configured physical machine. Accordingly, a virtual machine can have a virtual operating system (OS) (e.g., OS 230A for virtual machine 230A, OS 230B for virtual machine 232B, and OS 230C for virtual machine 232C). A virtual machine 232A-C can have access to the host computer system's hardware resources through hypervisor 202, which either runs directly on the host computer's hardware (i.e., a bare metal hypervisor) or runs within the host computer's operating system (i.e., a hosted hypervisor).

In some embodiments, hypervisor 202 can provide physical and/or virtual resources to operating systems 230A-C in any manner such that hypervisor 202 simulates any desirable operating system (e.g., Windows, Linux, Unix) to execute on virtual machines 232A-C. The system resources can include, for example, resources from hardware layer 210 and/or any other component included in virtualization environment 200. In these embodiments, hypervisor 202 can be used to partition physical hardware, emulate physical hardware, and/or execute virtual machines that provide users accessing virtualization environment 200 with various computing environments. In some embodiments, hypervisor 202 can control processor scheduling and memory partitioning for virtual machine(s) 232A-C executing in virtualization environment 200.

In some embodiments, hypervisor 202 can create virtual machines 232A-C, in which virtual operating systems 230A-C execute. As an example, hypervisor 202 can load a virtual machine image to create a virtual machine 232A-C. As another example, hypervisor 202 can execute virtual operating systems 230A-C within virtual machines 232A-C, respectively. Operating systems 230A-C are further described in detail below.

In some embodiments, hypervisor 202 of virtualization environment 200 can be a bare metal hypervisor, or a hypervisor that has direct access to applications and processes executing in the host computing system, resources on the host computing system, and hardware on the host computing system (e.g., hardware layer 210 shown in FIG. 2) or communicating with the host computing system. In some embodiments, a bare metal hypervisor can directly access all system resources. For example, if hypervisor 202 is a bare metal hypervisor, it can execute directly on one or more physical processors 208, and can retrieve data stored in one or more memories 212 and/or one or more graphic memories 214. By contrast, a host hypervisor accesses system resources through a host operating system (e.g., operating system 218).

In a virtualization environment that employs a bare metal hypervisor configuration, the host operating system (e.g., operating system 218) can be executed by one or more virtual machines 232. Thus, a user accessing virtualization environment 200 can designate one or more virtual machines 232 as a virtual machine for imitating the host operating system and allowing the user to interact with the virtual machine in substantially the same manner that the user would interact with the host computing system via host operating system 218.

Virtualization environment 200 can host or execute one or more virtual machines 232A-C. In some embodiments, a virtual machine 232A-C can be created for each user accessing virtualization environment 200, for each user requesting a virtual machine 232A-C, and/or for each user requesting a virtual desktop 240A-C. A virtual machine 232A-C can be a set of executable instructions that, when executed by physical processor(s) 208, imitate the operation of a physical computing device such that programs and processes can be executed on a virtual machine 232A-C in a manner similar to that on a physical computing device. It is appreciated that virtualization environment 200 can host any number of virtual machines 232A-C. In some embodiments, one or more virtual machines 232A-C can be provided, such as by hypervisor 202, with a unique virtual view of the physical hardware, memory, processor, and other system resources available to that virtual machine 232A-C (e.g., virtual disk 226A-C and/or virtual processor 228A-C). The unique virtual view can be based on, for example, virtual machine permissions, application of a policy engine to one or more virtual machine identifiers, the user accessing a virtual machine, the applications executing on a virtual machine, networks accessed by a virtual machine, or any other desired criteria. In some embodiments, a virtual machine 232A-C can be provided with a virtual view of resources that are substantially similar to the physical hardware, memory, processor, and/or other system resources available to the virtual machine 232A-C.

As shown in FIG. 2, virtual machines 232A-C can include one or more virtual disks 226A-C. Virtual disks 226A-C can correspond to, for example, one or more physical disks or one or more portions of a physical disk (e.g., physical disk(s) 204). As an example, virtual disk 226A can be allocated a first portion of physical disk(s) 204, virtual disk 226B can be allocated a second portion of physical disk(s) 204, and virtual disk 226C can be allocated a third portion of physical disk(s) 204. In some embodiments, one or more of virtual disks 226A-C can include one or more virtual disk partitions and/or file system(s), similar to those of a physical disk. For example, virtual disk 226A can include a virtual system disk, which includes virtual disk partitions and system files associated with virtual machine 232A. In some embodiments, the virtual system disk can be shared among virtual machines. For example, virtual machines 232B and 232C can have the same or similar system disk as virtual machine 232A.

The virtual file systems of virtual disks 226A-C can also include virtual files and/or folders. For example, virtual disk 226A can also include a virtual user disk, which can store user data such as user files and/or folders. In some embodiments, system and/or user data stored on a virtual system and/or user disk can be synchronized with disks stored in a server. The synchronization of a virtual system and/or a user disk between a virtual disk 226 and a server can performed, for example, to save data from the virtual system and/or user disk. In some embodiments, a virtual disk can also include a local disk. The local disk can store data associated with a virtual machine (e.g., virtual machine 232A-C) in persistent storage, such as in one or more physical disks 204 and/or memories 212.

In some embodiments, virtualization environment 200 can also include virtual apertures (not shown) in a virtual memory space, which can be a view of the virtual memory available to virtual machines 232A-C. The virtual apertures can correspond to, for example, physical caches, buffers, and/or memories, such as one or more memories 212, graphic memories 214, and/or internal or external physical disks such as hard disk(s) 204. As an example, under the circumstances that applications running on a virtual machine 232A-C do not require more memory than that which is available in one or more memories 212, the virtual apertures of a virtual machine 232A-C can correspond to a portion of one or more memories 212. As another example, under the circumstances that applications executed by a virtual machine 232A-C require more memory than that which is available in one or more memories 212, the virtual apertures of a virtual machine 232A-C can correspond to one or more portions of one or more memories 212, graphic memories 214, and/or physical disks 204. The virtual apertures can be generated, provided, and/or managed by hypervisor 202.

Virtual processors 228A-C can be virtualized views of one or more physical processors 208 of virtualization environment 200. In some embodiments, a virtualized view of physical processor(s) 208 can be generated, provided, and/or managed by hypervisor 202. In some embodiments, virtual processor(s) 228A-C can have substantially the same characteristics as those of physical processor(s) 208. In some embodiments, virtual processor(s) 228A-C can provide a modified view of physical processor(s) 208, such that at least some of the characteristics of virtual processor(s) 228A-C are different from the characteristics of corresponding physical processor(s) 208.

As shown in FIG. 2, a virtual operating system 230A-C can provide a user of a virtual machine 232A-C with a virtual desktop 240A-C corresponding to the virtual operating system 230A-C being executed on the virtual machine. For example, if a virtual machine 232A executes a virtual operating system 230A that is a virtualization of a Windows™ 7 operating system, virtual desktop 240A can be a virtualization of a desktop environment that is displayed to a user using a Windows™ 7 operating system. A user of a client device can interact with a virtual desktop of virtualization environment 200 to interact with virtual programs, applications, files, and/or other computing resources, similar to the way a user would interact with these resources on a physical computing device.

A client device can communicate with computer system 100 using a remote display protocol to access a virtualization environment 200. For example, a client application installed on a client device can allow the client device to communicate with a virtualization environment 200 through a communications protocol, such as independent computing architecture (ICA) protocol. This can allow a user to access resources within a virtualization environment 300. Such resources can include programs, applications, files, executable instruction codes, desktop environments 240A-C, computing environments, and/or other resources made available to users of virtualization environment 200.

In some embodiments, virtualization environment 200 can be implemented on one or more computer system 100. A client device accessing virtualization environment 200 can send input/output information corresponding to a user's interactions with a virtual desktop, and the client device can receive display information from virtualization environment 200 corresponding to the interactions. In some embodiments, all applications and data implemented by the virtual machine remain in a data center, with only display, keyboard, and mouse information being communicated between a client device and data center(s). For example, a user can select to open a Microsoft™ Word application from a virtual desktop, and keyboard and/or mouse commands can be transmitted from a client device of the user to data center(s). Data center(s) can open a virtualized version of Microsoft™ Word in a virtualized desktop 232A in a virtualization environment 200, and can send an image frame of the virtual desktop with Microsoft™ Word opened to the client device for display. In this way, information regarding client interactions is transmitted from a client device to a virtualization environment, software is executed in virtualization environment to implement changes to a virtual desktop, and updated image frames are transmitted to the client device to display the changes to the virtual desktop. Alternatively, the client application can be configured to execute a portion of the virtualization environment 200 on the client device, so that some of the software associated with the virtualization environment 200 is executed at the client device, and other software associated with the virtualization environment 200 is executed at one or more data centers.

In some embodiments, each user requesting access to virtualization environment 200 can be provided their own virtual machine 230A-C. For example, a first user of a client device can request a virtualized Windows™ 7 computing environment, and can be provided with virtual machine 232A implementing a virtual Windows™ 7 operating system. A second user of another client device can request a virtualized Linux computing environment, and can be provided with a virtual machine 232B implementing a virtual Linux operating system at the same time as virtual machine 232A is being provided to the first user. And although three virtual machines 232A-C are illustrated in exemplary virtualization environment 200 of FIG. 2, the disclosure is not so limited. Virtualization environment 200 can provide any number of virtual machines to any number of client devices. In some embodiments, each client device requesting access to virtualization environment 200 can be provided with its own virtual machine 232A. In some other embodiments, a plurality of client devices can share a virtual machine. One or more computer systems 100 implementing a virtualization environment 200 can dynamically allocate virtual machines as requested by client devices. That is, when a user has stopped using a virtual machine, computing system(s) 100 can close the virtual machine and re-allocate the computing resources being utilized for that virtual machine, so that the resources can be used for other purposes (e.g., for other virtual machines).

Virtualization environment 200 can also determine characteristics of one or more physical monitors 124 connected to a client device accessing virtualization environment 200, and can generate one or more virtual monitors 250A-C that virtualize the display of a desktop 240A-C on a physical monitor having those characteristics. The characteristics can include, for example, an aspect ratio, resolution, size, dimension, type, refresh rate, number of pixels, supported video format, or contrast of a physical monitor 124 connected to a client device. For example, virtualization environment 200 can identify a client device accessing virtualization environment 200 as having a touch sensitive tablet display of a certain resolution, such as 1024×768 pixels. Virtualization environment 200 can provide the client device with virtual desktop 240A of a virtual machine 232A running a virtual operating system 230A, and create one or more virtual monitors 250A corresponding to the characteristics of the monitor 124 of the client device. Images of virtual desktop 240A can then be provided to the client device using virtual monitors 250A, so that the images are captured with characteristics that correspond to the characteristics of a physical monitor 124 connected to the client device. For example, a virtual monitor 250A can be created with a 1024×768 pixel resolution, so that images of virtual desktop 240B are captured and provided to the client device with the same resolution as a physical monitor 124 connected to the client device. Accordingly, virtualization environment 200 can provide a plurality of different virtual desktops 240A-C in a plurality of different virtual monitors 250A-C to a plurality of different client devices having different types of physical monitors 124. In some embodiments, virtual monitor(s) 250A-C may not necessarily correspond to physical monitors. For example, a user of a client device accessing virtualization environment 200 can select any desired monitor characteristics for the one or more virtual monitors provided for the user's virtual machine. Alternatively, virtualization environment 200 can be pre-configured to create virtual monitors 250A-C having certain characteristics.

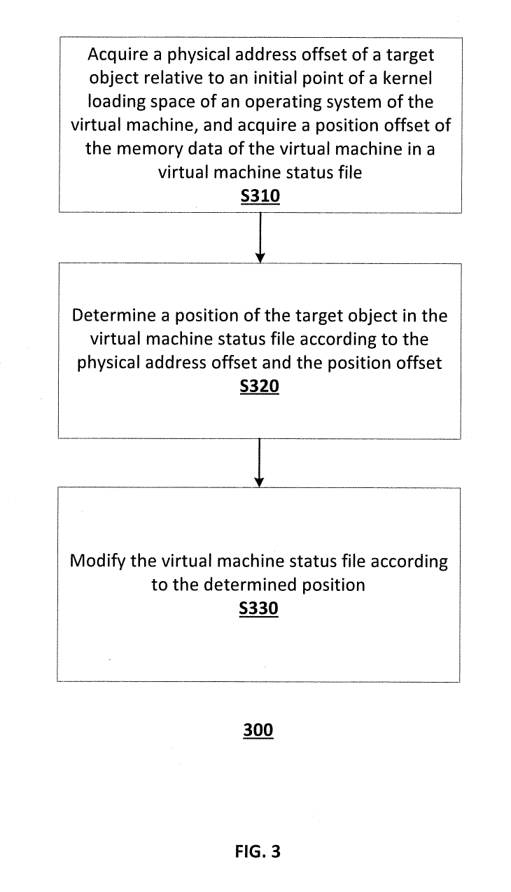

FIG. 3 illustrates a method 300 for modifying memory data of a virtual machine, consistent with embodiments of the disclosure. Method 300 can include steps S310-S330 as below. It is appreciated that steps S310-S330 may be performed by software and/or hardware within a computer system, such as a computer system 100 of FIGS. 1A-1B. And a host of the virtual machine (e.g., virtual machines 232A-232C) can be implemented by computer system 100.

In step S310, a physical address offset of a target object relative to an initial point of a kernel loading space of an operating system of the virtual machine can be acquired, and a position offset of the memory data of the virtual machine in a virtual machine status file can be acquired. The virtual machine status file may be, but is not limited to, a Virtual Machine Snapshot (VMSS) file. In some embodiments, the sequence of acquiring the physical address offset and acquiring the position offset is not limited, and the physical address offset and the position offset may also be acquired concurrently.

In some embodiments, the acquiring a physical address offset of a target object relative to an initial point of a kernel loading space of an operating system of the virtual machine may include: acquiring a virtual address of the target object; and subtracting an initial virtual address of kernel loading space of the operating system of the virtual machine from the virtual address of the target object, and using the subtraction result as the physical address offset.

In some embodiments, the acquiring position offset of the memory data of the virtual machine in a virtual machine status file can be regarded as a relative position of an area for saving the memory data of the virtual machine in the virtual machine status file.

In step S320, a position of the target object in the virtual machine status file can be determined according to the physical address offset and the position offset. In some embodiments, the determining a position of the target object in the virtual machine status file according to the physical address offset and the position offset may include: obtaining an initial position of the target object in the virtual machine status file according to the physical address offset, the position offset, and an initial physical address of the kernel loading space of the operating system of the virtual machine.

Generally, the kernel loading space of the operating system of the virtual machine would not start from an initial point of a memory physical space of the virtual machine. That is, an initial physical address of kernel loading space of the operating system of the virtual machine is oftentimes not “0” (e.g., the initial point of the memory physical space). Therefore, the relative position of the target object in the memory physical space of the virtual machine can be determined according to an initial physical address of the kernel loading space of the operating system of the virtual machine and the physical address offset, and then an initial address of the target object in the virtual machine status file can be obtained according to the position offset.

For example, there is an offset d1 between the initial point of the kernel loading space of the operating system of the virtual machine and the initial point of the memory physical space of the virtual machine, and there is also an offset d2 between the initial point of the target object and the initial point of the kernel loading space of the operating system of the virtual machine (e.g., the physical address offset in step S110). d1+d2 is equivalent to an offset of the initial point of the target object relative to the initial point of the memory physical space of the virtual machine. For example, if a physical address of the initial point of the memory physical space of the virtual machine is 0, the offset d1 can be equal to an initial physical address of kernel loading of the operating system of the virtual machine, and d1+d2 is equivalent to an initial address of the target object in the memory physical space of the virtual machine. By adding d1+d2 and the position offset, an initial address of the target object in the virtual machine status file can be obtained.

In step S330, the virtual machine status file can be modified according to the determined position. In some embodiments, the memory data of the virtual machine can be modified in a virtual machine status file. Data in the virtual machine status file is saved by a virtual machine supervision program (e.g., ESXi, Workstation, KVM, Xen, and the like) through a checkpoint mechanism when the VM is in a Suspend or Save state (which may correspond to a Hibernate mode of a physical machine). When the VM is in a Resume or Restore state (which may correspond to the waking up of the physical machine), the status of the virtual machine may be resumed according to the virtual machine status file. The virtual machine status file can include a status of a virtual device of the VM, and the memory of the VM may be regarded as a special virtual device of the VM. Therefore, the data in the virtual machine status file can include all memory data of the VM. In a Resume/Restore process, the memory of the VM may not be verified and detected. Therefore, offline modification on the memory data of the VM may be implemented by modifying data at corresponding positions in the virtual machine status file, and any byte in the memory of the virtual machine may be modified. In some embodiments, if the virtual machine status file has been compressed, the modification can be made after the virtual machine status file is obtained through decompression.

In some embodiments, by acquiring the physical address offset of the target object relative to the initial point of the kernel loading space of the operating system of the virtual machine, a relative position of the target object in a memory physical space of the virtual machine can be determined. When the status of the virtual machine is saved, memory data in the memory physical space of the virtual machine can be correspondingly written into the virtual machine status file sequentially byte by byte, strictly according to physical addresses. Therefore, the relative position of the target object in the memory physical space of the virtual machine is a relative position of the target object in an area, in the virtual machine status file, for saving the memory data of the virtual machine.

In some embodiments, after the relative position of the target object in the memory physical space of the virtual machine and the relative position of the area for saving the memory data of the virtual machine in the virtual machine status file are acquired, the target object can be located in the virtual machine status file, and thus modification can be made.

In some embodiments, when data is modified in the virtual machine status file, modification can be completed by using a file modification command, and the efficiency for modifying data can be improved.

This implementation is applicable to a situation where a mapping relationship between a virtual address and a physical address is a linear mapping. For example, when the operating system of the virtual machine uses a 64-bit Linux kernel, the mapping relationship is linear. In this situation, a virtual address offset can be obtained by subtracting an initial virtual address of kernel loading space of the operating system of the virtual machine from the virtual address of the target object. The virtual address offset is equivalent to the physical address offset.

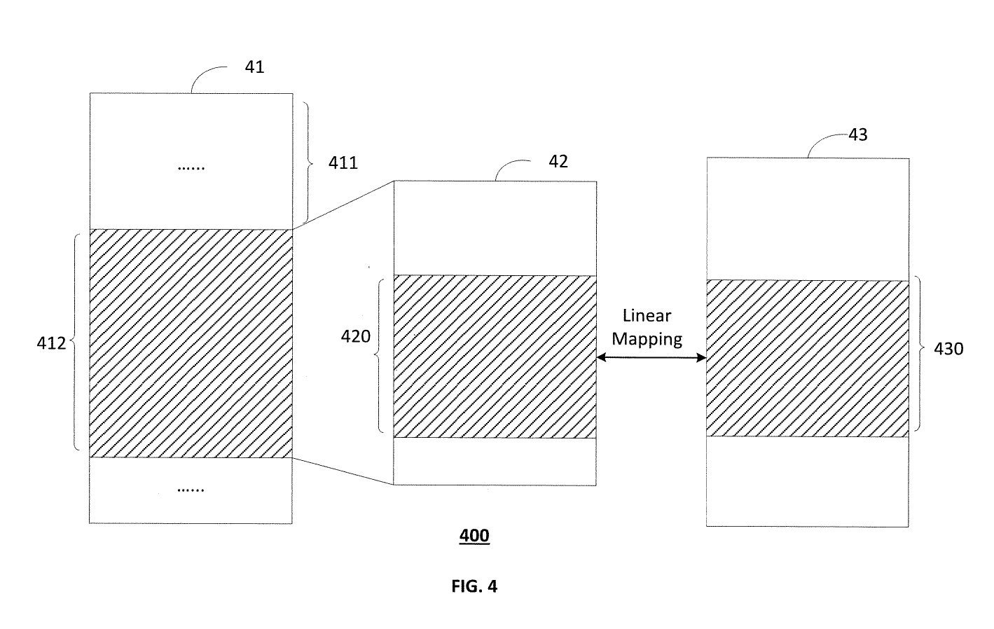

FIG. 4 further illustrates an implementation principle 400 of the method, consistent with embodiments of the disclosure.

As shown in FIG. 4, a virtual machine status file 41 can occupy a continuous storage area, including an area 412 for saving memory data of the virtual machine. An offset between an initial point of the area 412 and an initial point of the virtual machine status file 41 is indicated by 411. Therefore, offset 411 indicates the position offset.

Data in the area 412 for saving memory data of the virtual machine is correspondingly identical with data in a memory physical space 42 of the virtual machine. A kernel loading space 420 of an operating system of the virtual machine is included in the memory physical space 42 of the virtual machine, wherein there is a linear corresponding relationship between the kernel loading space 420 and a kernel loading virtual address space 430 in a memory virtual address space 43 of the virtual machine, and an initial physical address of the kernel loading space of the operating system of the virtual machine corresponds to an initial virtual address of the kernel loading space of the operating system of the virtual machine. Therefore, in the kernel loading virtual address space 430, an offset of a virtual address relative to an initial virtual machine address is equal to an offset of a physical address corresponding to the virtual address relative to an initial physical address in the kernel loading space 420. That is, when the initial virtual address and the initial physical address are known, a physical address corresponding to a virtual address can be determined according to the virtual address. For example, the physical address can be determined as:

initial virtual address+(virtual address−initial virtual address); and

(virtual address−initial virtual address) can be the virtual address offset, which corresponds to the physical address offset.

In some embodiments, the mapping relationship between the virtual address and the physical address may not be linear. For example, the mapping relationship can be non-linear, and a physical address offset may also be determined according to the virtual address offset and the mapping relationship, as long as the mapping relationship is known.

The virtual address of the target object can be read from a kernel symbol file. A kernel symbol can be either a variable or a function, and represent a space in the memory. The kernel symbol file can store a plurality of kernel symbols. In addition, the initial physical address and initial virtual address of the kernel loading space can be read from the kernel symbol file. In some embodiments, the virtual address of the target object read from a kernel symbol file corresponding to a kernel version of the operating system of the virtual machine can be acquired before the acquisition of a physical address offset of a target object relative to an initial point of a kernel loading space of the operating system of the virtual machine.

In some embodiments, a position offset of the memory data of the virtual machine in a virtual machine status file can be acquired. For example, an offset of an initial point of the memory data of the virtual machine relative to an initial point of the virtual machine status file in the virtual machine status file can be acquired through a virtual machine supervision program.

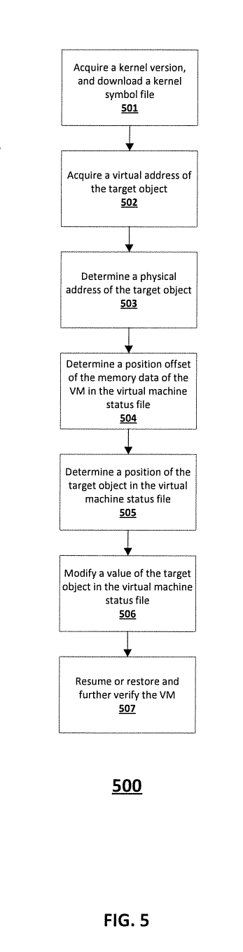

FIG. 5 is a flowchart of a modification process 500, consistent with embodiments of the disclosure. According to these embodiments, it is assumed that the operating system of the virtual machine is a Redhat™ Enterprise Linux (RHEL), the virtual machine status file is a VM Scale Sets (VMSS) file, and the target object is a global variable: unknown_nmi_panic. Hereinafter, “0x” indicates that it is followed by a hexadecimal number. Modification process 300 can include steps 501-507.

In step 501, a RHEL kernel version can be acquired, and a kernel symbol file (e.g., a vmlinux file) can be downloaded according to the kernel version. Step 501 can be implemented by using the following code: stringsvm_save| grep vmlinux.

In step 502, a virtual address of the target object (e.g., unknown_nmi_panic) can be acquired. Step 502 can be implemented by using the following code:

readelf -s vmlinux | grep unknown_nmi_panic.

The obtained result is, for example, as follows:

ffffffff81de1260 4 OBJECT GLOBAL DEFAULT 32 unknown_nmi_panic, According to the above result, the virtual address of unknown_nmi_panic is ffffffff81de1260.

In step 503, a physical address of the target object (e.g., unknown_nmi_panic) can be determined. Generally, an initial physical address of RHEL kernel loading can be 0x01000000 (i.e., 16M), an initial virtual address of RHEL kernel loading can be 0xffffffff81000000, and a mapping relationship between a virtual address and a physical address in the kernel is linear. Therefore, the physical address of unknown_nmi_panic can be determined as below:

0x01000000+(0xffffffff81de1260-0xffffffff81000000)=0x01de1260

A virtual address offset is obtained according to (0xffffffff81de1260-0xffffffff81000000). As there is linear mapping between the virtual address and the physical address, the virtual address offset is equivalent to the physical address offset in the above step S110. The physical address of unknown_nmi_panic is equivalent to the offset between the position of unknown_nmi_panic and the initial point of the memory data of the virtual machine.

In step 504, a position offset of the memory data of the VM in the virtual machine status file can be determined.

Some virtual machine software can provide a tool to analyze a virtual machine status file. For example, the virtual machine software VMware™ provides vmss2core for analyzing a virtual machine status file (which is generally vmss) corresponding to its own product (e.g., ESXi, Workstation). Other virtual machine supervision programs may have similar tools. Through the tools, the offset of the memory data of the VM in the virtual machine status file can be acquired.

Alternatively, a field may also be queried in the source code of a virtual machine supervision program, to acquire the offset of the memory data of the VM in the virtual machine status file.

For example, the code of a virtual machine supervision program can be as follows:

```
  vmss2core -C vm_save.vmss| grep memory −3
  Group memory offs 0x1cc2a size 0x400033d8.
  tagalign_mask [0][0]: size 0x4 position 0x1cc3e: 0000FFFF
  tagregionsCount : size 0x4 position 0x1cc50: 00000000
  tag Memory [0][0]: BLOCK: size 0x40000000 memSize 0x40000000
position 0x20000
```

It can be known from the above codes that the position offset of the area for saving the memory data of the VM in the virtual machine status file is 0x20000.

In step 505, a position of the target object (e.g., unknown_nmi_panic) in the virtual machine status file (e.g., VMSS) can be determined (such as shown below), and the position may also be regarded as an offset:

0x20000+0x01de1260=0x1e01260=31461984

In step 506, a value of the target object (e.g., unknown_nmi_panic) in the virtual machine status file (e.g., VMSS) can be modified. The value before modification can be acquired by using the following code:

xxd -s 0x1e01260 -1 4 -g 1 vm_save.vmss

The acquired result can be as follows:

1e01260: 00 00 00 00

The value of unknown_nmi_panic can be modified by using the following code:

printf ″\xab\xab\xab\xab″ | ddof=vm_filebs=1 count=4 conv=
notruncbs=1 count=4 seek=31461984

The value after modification can be acquired by using the following code:

xxd -s 0x1e01260-1 4 -g 1vm_save.vmss

The acquired result can be as follows:

1e01260: ab ababab

In step 507, the VM can be resumed or restored, and can be further verified. The virtual machine can be logged in to execute the following command:

sysctlkernel.unknown_nmi_panic

The obtained result is as follows:

kernel.unknown_nmi_panic=1

It is thus clear that, through the above steps, the value of unknown_nmi_panic changes from 0 to 1.

The sequence of the above steps 501-504 is not limited by the above example, and the steps may also be performed concurrently. In addition, the manner of determining the position of unknown_nmi_panic in the VMSS file may not be limited to the practice of the above steps 501-505. For example, the position of unknown_nmi_panic in the VMSS file may also be obtained by adding the initial physical address to the position offset obtained in step 504, adding the virtual address obtained in step 402, and subtracting the initial virtual address.

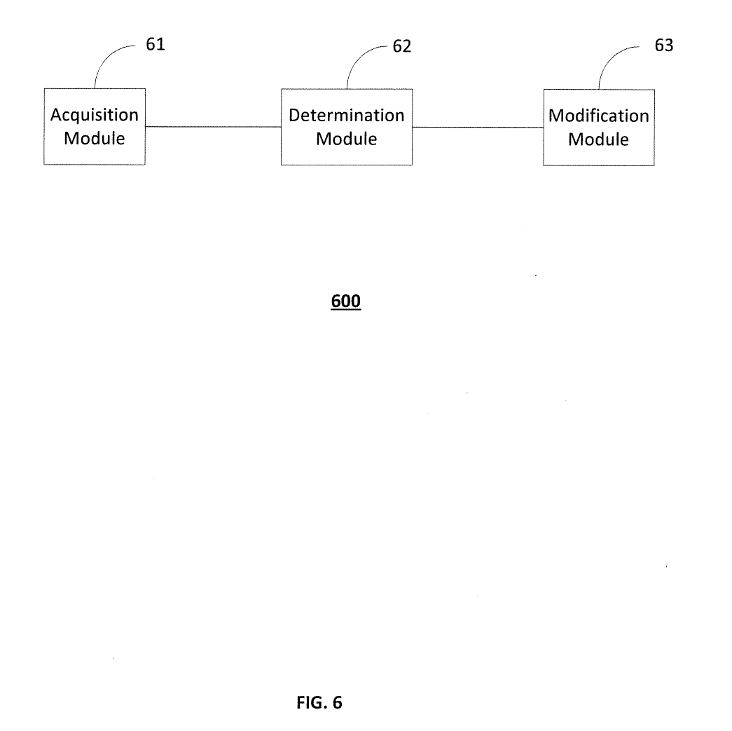

FIG. 6 further illustrates an apparatus 600 for modifying memory data of a virtual machine, consistent with embodiments of the disclosure. Apparatus 600 can include: an acquisition module 61, a determination module 62, and a modification module 63.

In general, these modules (and any sub-modules), can be a packaged functional hardware unit designed for use with other components (e.g., portions of an integrated circuit) and/or a part of a program (stored on a computer readable medium) that performs a particular function of related functions. The module can have entry and exit points and can be written in a programming language, such as, for example, Java, Lua, C, or C++. A software module can be compiled and linked into an executable program, installed in a dynamic link library, or written in an interpreted programming language such as, for example, BASIC, Perl, or Python. It will be appreciated that software modules can be callable from other modules or from themselves, and/or can be invoked in response to detected events or interrupts. Software modules configured for execution on computing devices can be provided on a computer readable medium, such as a compact disc, digital video disc, flash drive, magnetic disc, or any other non-transitory medium, or as a digital download (and can be originally stored in a compressed or installable format that requires installation, decompression, or decryption prior to execution). Such software code can be stored, partially or fully, on a memory device of the executing computing device, for execution by the computing device. Software instructions can be embedding in firmware, such as an EPROM. It will be further appreciated that hardware modules can be comprised of connected logic units, such as gates and flip-flops, and/or can be comprised of programmable units, such as programmable gate arrays or processors. The modules or computing device functionality described herein are preferably implemented as software modules, but can be represented in hardware or firmware. Generally, the modules described herein refer to logical modules that can be combined with other modules or divided into sub-modules despite their physical organization or storage.

Acquisition module 61 can be configured to acquire a physical address offset of a target object relative to an initial point of a kernel loading space of an operating system of the virtual machine, and acquire a position offset of the memory data of the virtual machine in a virtual machine status file.

Acquisition module 61 can be configured to acquire a virtual address of the target object; and subtract an initial virtual address of the kernel loading space of the operating system of the virtual machine from the virtual address of he target object, and use the subtraction result as the physical address offset.

In some embodiments, before acquiring the physical address offset of the target object relative to the initial point of the kernel loading space of the operating system of the virtual machine, acquisition module 61 is further configured to acquire a kernel version of the operating system of the virtual machine, and acquire a corresponding kernel symbol file according to the kernel version; and read the virtual address of the target object from the acquired kernel symbol file.

Acquisition module 61 can be further configured to acquire an offset of an initial point of the memory data of the virtual machine relative to an initial point of the virtual machine status file in the virtual machine status file through a virtual machine supervision program.

Determination module 62 can be configured to determine a position of the target object in the virtual machine status file according to the physical address offset and the position offset. In some embodiments, determination module 62 can be further configured to obtain an initial position of the target object in the virtual machine status file according to the physical address offset, the position offset, and an initial physical address of the kernel loading space of the operating system of the virtual machine.

Modification module 63 can be configured to modify the virtual machine status file according to the determined position.

The operations performed by modules 61-63 of apparatus 600 can correspond to steps S310-S330 respectively, and details of modules 61-63 will be omitted herein for clarity.

Embodiments of the disclosure further provide an electronic device for modifying memory data of a virtual machine. The electronic device can at least include: a memory and a processor.

The memory can be configured to store instructions for modifying the memory data of the virtual machine, and when the instructions are read and executed by the processor, the following operations can be performed:

acquiring a physical address offset of a target object relative to an initial point of a kernel loading space of an operating system of the virtual machine, and acquiring a position offset of the memory data of the virtual machine in a virtual machine status file;

determining a position of the target object in the virtual machine status file according to the physical address offset and the position offset; and

modifying the virtual machine status file according to the determined position.

In some embodiments, the performed operations can correspond to steps S310-S330 described above, and details of the performed operations will be omitted herein for clarity.

Embodiments of the disclosure further provide a non-transitory computer-readable medium storing instructions that are executable to cause one or more processors to perform at least some of the steps from the methods, as discussed above. The computer-readable medium can include volatile or non-volatile, magnetic, semiconductor, tape, optical, removable, flash memory, non-removable, or other types of computer-readable medium or computer-readable storage devices. For example, the computer-readable medium can be the storage device or the memory module having the computer instructions stored thereon, as disclosed. Detailed description of these components will be omitted herein for clarity.

It is appreciated that all or some steps in the above method may be completed by instructing related hardware through a program. The program may be stored in a computer readable storage medium, for example, a read-only memory, a magnetic disk, an optical disc or the like. Optionally, all or some steps of the above embodiments may also be implemented by using one or more integrated circuits. Correspondingly, as indicated above, the modules/units in the above embodiments may be implemented in the form of hardware, and may also be implemented in the form of software functional modules.

Certainly, the present disclosure may also have many other embodiments. Those skilled in the art can make various corresponding changes and transformations according to the present disclosure without departing from the spirit of the present disclosure and the essence thereof. However, the corresponding changes and transformations should all fall within the protection scope of the claims of the present disclosure.

1. A method for modifying memory data of a virtual machine, comprising:
acquiring a physical address offset of a target object relative to an initial point of a kernel loading space of an operating system of the virtual machine, and acquiring a position offset of the memory data of the virtual machine in a virtual machine status file;
determining a position of the target object in the virtual machine status file according to the physical address offset and the position offset; and
modifying the virtual machine status file according to the determined position.

2. The method according to claim 1, wherein determining a position of the target object in the virtual machine status file according to the physical address offset and the position offset further comprises:
obtaining an initial position of the target object in the virtual machine status file according to the physical address offset, the position offset, and an initial physical address of the kernel loading space of the operating system of the virtual machine.

3. The method according to claim 1, wherein acquiring a physical address offset of a target object relative to an initial point of a kernel loading space of an operating system of the virtual machine further comprises:
acquiring a virtual address of the target object; and
subtracting an initial virtual address of the kernel loading space of the operating system of the virtual machine from the virtual address of the target object, and using the subtraction result as the physical address offset.

4. The method according to claim 3, further comprising:
acquiring a kernel version of the operating system of the virtual machine, and acquiring a corresponding kernel symbol file according to the kernel version; and
reading the virtual address of the target object from the acquired kernel symbol file.

5. The method according to claim 1, wherein acquiring a position offset of the memory data of the virtual machine in a virtual machine status file further comprises:
acquiring, through a virtual machine supervision program, an offset of an initial point of the memory data of the virtual machine relative to an initial point of the virtual machine status file in the virtual machine status file.

6. An apparatus for modifying memory data of a virtual machine, comprising:
an acquisition module configured to acquire a physical address offset of a target object relative to an initial point of a kernel loading space of an operating system of the virtual machine, and acquire a position offset of the memory data of the virtual machine in a virtual machine status file;
a determination module configured to determine a position of the target object in the virtual machine status file according to the physical address offset and the position offset; and
a modification module configured to modify the virtual machine status file according to the determined position.

7. The apparatus according to claim 6, wherein the determination module is further configured to:
obtain an initial position of the target object in the virtual machine status file according to the physical address offset, the position offset, and an initial physical address of the kernel loading space of the operating system of the virtual machine.

8. The apparatus according to claim 7, wherein the acquisition module is further configured to:
acquire a virtual address of the target object; and
subtract an initial virtual address of kernel loading of the operating system of the virtual machine from the virtual address of the target object, and use the subtraction result as the physical address offset.

9. The apparatus according to claim 8, wherein the acquisition module is further configured to:
acquire a kernel version of the operating system of the virtual machine, and acquire a kernel symbol file corresponding to the kernel version; and
read the virtual address of the target object from the acquired kernel symbol file.

10. The apparatus according to claim 6, wherein the acquisition module is further configured to:
acquire, through a virtual machine supervision program, an offset of an initial point of the memory data of the virtual machine relative to an initial point of the virtual machine status file in the virtual machine status file.

11. An electronic device for modifying memory data of a virtual machine, comprising:
a memory configured to store instructions for modifying the memory data of the virtual machine; and
a processor configured to execute the instructions to cause the electronic device to:
acquire a physical address offset of a target object relative to an initial point of a kernel loading space of an operating system of the virtual machine, and acquire a position offset of the memory data of the virtual machine in a virtual machine status file;
determine a position of the target object in the virtual machine status file according to the physical address offset and the position offset; and
modify the virtual machine status file according to the determined position.

12. A non-transitory computer readable medium that stores a set of instructions that is executable by at least one processor of an electronic device to cause the device to perform a method for modifying memory data of a virtual machine, the method comprising:
acquiring a physical address offset of a target object relative to an initial point of a kernel loading space of an operating system of the virtual machine, and acquiring a position offset of the memory data of the virtual machine in a virtual machine status file;
determining a position of the target object in the virtual machine status file according to the physical address offset and the position offset; and
modifying the virtual machine status file according to the determined position.

13. The non-transitory computer readable medium according to claim 12, wherein the set of instructions is executable by the at least one processor of the device to cause the device to further perform:
obtaining an initial position of the target object in the virtual machine status file according to the physical address offset, the position offset, and an initial physical address of the kernel loading space of the operating system of the virtual machine.

14. The non-transitory computer readable medium according to claim 12, wherein the set of instructions is executable by the at least one processor of the device to cause the device to further perform:
acquiring a virtual address of the target object; and
subtracting an initial virtual address of the kernel loading space of the operating system of the virtual machine from the virtual address of the target object, and using the subtraction result as the physical address offset.

15. The non-transitory computer readable medium according to claim 14, wherein the set of instructions is executable by the at least one processor of the device to cause the device to further perform:
acquiring a kernel version of the operating system of the virtual machine, and acquiring a corresponding kernel symbol file according to the kernel version; and
reading the virtual address of the target object from the acquired kernel symbol file.

16. The non-transitory computer readable medium according to claim 12, wherein the set of instructions is executable by the at least one processor of the device to cause the device to further perform:
acquiring, through a virtual machine supervision program, an offset of an initial point of the memory data of the virtual machine relative to an initial point of the virtual machine status file in the virtual machine status file.
